(19) United States
(12) Patent Application Publication
(10) Pub. No.: US 2010/0037609 A1
(43) Pub. Date: Feb. 18, 2010

(54) Motor Vehicle and Method for Operating a Motor Vehicle with an Exhaust-Gas Heating Apparatus

(75) Inventors: JÖRG-ROMAN KONIECZNY, Much (DE); ROLF BRÜCK, Bergisch Gladbach (DE); JAN HODGSON, Troisdorf (DE)

Correspondence Address: LERNER GREENBERG STEMER LLP, P O BOX 2480, HOLLYWOOD, FL, 33022-2480, US

(73) Assignee: EMITEC GESELLSCHAFT FUR EMISSIONSTECHNOLOGIE MBH, Lohmar (DE)

(21) Appl. No.: 12/536,570

(22) Filed: Aug. 6, 2009

Related U.S. Application Data
(63) Continuation of application No. PCT/EP2008/050476, filed on Jan. 17, 2008.

(30) Foreign Application Priority Data
Feb. 6, 2007 (DE) 10 2007 006 625.4
Jun. 22, 2007 (DE) 10 2007 028 915.6

(51) Int. Cl. F02G 3/00; F01N 5/02

(52) U.S. Cl. 60/614; 60/320

(57) ABSTRACT

A method for operating a motor vehicle which has, as components, a drive device, an exhaust system for exhaust gases of the drive device, at least one heating apparatus of the exhaust system and at least one energy converter, includes at least the following steps: (a) detecting a possibility of energy recovery, (b) activating the at least one energy converter, (c) feeding energy recovered by the at least one energy converter to the heating apparatus, (d) operating the heating apparatus for heating the exhaust gas with the recovered energy, and (e) detecting an end of the possibility of energy recovery, after which the energy converter is deactivated and the recovery of energy is ended. A motor vehicle for carrying out the method is also provided.

### CROSS-REFERENCE TO RELATED APPLICATION

This is a continuing application, under 35 U.S.C. §120, of copending International Application No. PCT/EP2008/050476, filed Jan. 17, 2008, which designated the United States; this application also claims the priority, under 35 U.S.C. §119, of German Patent Applications DE 10 2007 006 625.4, filed Feb. 6, 2007 and DE 10 2007 028 915.6, filed Jun. 22, 2007; the prior applications are herewith incorporated by reference in their entirety.

### BACKGROUND OF THE INVENTION

1. Field of the Invention

The present invention relates to a method for operating a motor vehicle which has, as components, a drive device, an exhaust system for exhaust gases from the drive device, at least one heating apparatus of the exhaust system, and at least one energy converter. The invention also relates to a motor vehicle for carrying out the method. The invention can be used in particular in the field of automotive engineering.

It is considered to be known to place the exhaust gas generated by an engine of a motor vehicle in contact with a heating apparatus in order to influence the temperature of the exhaust gas. Furthermore, it is also considered to be known that heating apparatuses of that type are used, for example directly after a cold start or restart of an engine or of an exhaust system, to quickly bring the exhaust gases or the exhaust-gas purification components which are optionally provided with a catalytically active coating up to a reaction temperature, in particular up to a temperature at which an interaction of the catalytic converter with the pollutants of the exhaust gas takes place.

Heating apparatuses which have already been proposed are in particular those which are heated as a result of ohmic resistance heating. An electrical conductor, which is traversed by current at desired times, is heated up due to its resistance and can thereby heat the catalytically active material which is positioned thereon and/or the contacted exhaust gas. There are various configurations of heating apparatuses of that type. In particular, wire-grate constructions, honeycomb bodies, plate constructions and the like have already been described.

With regard to the operation taking place in heating apparatuses of that type, it is likewise considered to be known that the heating apparatuses have been activated before or during the starting of the engine or if appropriate shortly after the starting of the engine in order to improve the cold-start behavior for a limited time period, with it having been taken into consideration in particular that an electrical overload of the battery of the vehicle is prevented. Furthermore, it is also known to use heating apparatuses of that type in combination with particle filters in order to permit a thermal regeneration of trapped particles in that case if required (for example in the event of an impending blockage of the particle filter). For that purpose, it is known to activate the heating apparatuses when a predefined operating time period has elapsed and/or the particle loading in the filter has reached a predefined value.

The known applications and/or strategies for use have however only partially led to the desired results. It was in particular found that the use of the heating apparatus resulted in part in an undesirably high energy requirement and the activation cycles in part took up very long time periods.

### SUMMARY OF THE INVENTION

It is accordingly an object of the invention to provide a motor vehicle and a method for operating a motor vehicle with an exhaust-gas heating apparatus, which overcome the hereinafore-mentioned disadvantages and at least partially solve the highlighted problems of the heretofore-known devices and methods of this general type and which permit the use of such heating apparatuses in exhaust systems of mobile internal combustion engines in an energy-saving and effective manner.

With the foregoing and other objects in view there is provided, in accordance with the invention, a method for operating a motor vehicle having components including a drive device, an exhaust system for exhaust gases from the drive device, at least one heating apparatus of the exhaust system, and at least one energy converter. The method comprises at least the following steps:
(a) detecting a possibility of energy recovery;
(b) activating the at least one energy converter;
(c) supplying energy recovered by the at least one energy converter to the heating apparatus;
(d) operating the heating apparatus in order to heat the exhaust gas with the recovered energy; and
(e) detecting an end of the possibility of energy recovery and subsequently deactivating the energy converter and ending the energy recovery.

The method according to the invention therefore relates in particular to the regulation of a heating apparatus which is in contact with the exhaust gas of a motor vehicle engine, in such a way that a desired target parameter of the exhaust system or a component therein is reliably reached.

The drive device can, in addition to known diesel or gasoline engines, relate also to any other comparable drives which ultimately generate a pollutant-laden exhaust gas or an exhaust gas which must be subjected to temperature treatment. This also includes hybrid drives or drive devices which are based on alternative energy sources and which emit exhaust gases. The “exhaust system” is often formed by a line (or a plurality of lines), in particular in the manner of a tubular line. The exhaust system, which conducts the exhaust gas in a preferred flow direction, now has provided in it at least one heating apparatus which in particular at least partially spans the inner cross section of the exhaust system. In this case, the heating apparatus preferably forms passages, ducts or the like through which the exhaust gas flows, with a large contact surface being produced. The heating apparatus can also have further functions in addition to its heating function, for example a catalytic conversion, accumulation or deflection of exhaust-gas constituents.

In step (a), a possibility of energy recovery is firstly detected. This takes place for example by virtue of at least one driving and/or operating state of the motor vehicle being monitored (preferably continuously) through the use of a control device. In predetermined states in which it is possible to recover energy, a corresponding signal is then generated which indicates that there is the possibility of energy recovery. In this case, within the context of the invention, it is selectively possible to take current, that is to say instantaneous states into consideration for determining the possibility of energy recovery. It is however by all means also possible to take into consideration future states, which are to be expected, in the detection of possibilities of energy recovery. This may take place for example through the use of a GPS navigation device. For example, if it is detected that a vehicle is situated on a relatively long stretch of gradient and the direction of travel is also downhill, then it is to be expected that the vehicle will be operated predominantly in the braking or idle state in the immediate future, and energy recovery will therefore be possible. In addition to such a very particularly advantageous driving state, which constitutes an excellent possibility of energy recovery, it is however also possible for energy recovery to be carried out in numerous other states or situations. These include for example braking processes from high speeds, or else relatively short stretches of gradient.

In the subsequent step (b) of the method, at least one energy converter is then activated. If, as a result of step (a), a signal is output which indicates the possibility of energy recovery, then step (b) activates the energy converter as a result of the signal. The energy converter then preferably recovers kinetic energy which is stored or generated in the vehicle, and converts that kinetic energy into a different form of energy (preferably electricity)—recuperation. In addition to the conversion of kinetic energy, it is also conceivable in this case to convert potential energy of the motor vehicle. This could take place for example as a result of changes in height within the context of the chassis kinematics, where spring travels can be utilized for energy recovery.

Consideration is given, for example, to current generators as energy converters. They can convert the rotational movements of the wheels (in particular the braking energy) or of the drive elements of the vehicle into electrical current. Alternatively, in hybrid vehicles, it is also possible for the electric motors thereof, which in a driving state serve to drive the vehicle, to be utilized in the overrun mode as generators for generating electrical current. Other forms of energy converters may be compressors which convert rotational movements for example of the drive elements into pressure potentials of compressed air storage devices, which are later indirectly or directly re-used.

In step (c), the energy which is recovered by the at least one energy converter is then supplied to the heating apparatus. In the simplest case, this takes place over lines, such as for example in the form of electrical lines if the recovered energy is present in the form of electrical currents. Step (c) may likewise take place in multiple stages, for example with an energy storage device firstly being supplied with the recovered energy and that energy being supplied to the heating apparatus at a later time according to demand. The charging of the energy storage device may also take place at the same time as or parallel to the supply of the recovered energy to the heating apparatus.

The method according to the invention also provides that, in step (d), the heating apparatus is operated with the recovered energy in order to heat the exhaust gas. In this case, the heating apparatus may act directly or indirectly on the exhaust gas which is to be heated. In the case of a heater which acts directly, heating coils are for example provided which are disposed directly in the exhaust-gas flow and around which the exhaust gas flows. If, for example, the heating coils are placed into a glowing state by electrical current, then the energy which is provided is dissipated from the heating apparatus to the exhaust gas which flows around them, and the exhaust gas is thereby heated. The exhaust gas which is heated in this way can then more quickly reach the temperatures required for complete exhaust-gas purification. During the operation of a direct heating apparatus, the latter may for example act on the honeycomb body or other components of the exhaust system. This means that the exhaust system or the components thereof are heated by the heating apparatus, and then in turn heat the exhaust gas which flows through the exhaust system. This results in the direct mode of operation of the heating apparatus.

Depending on the embodiment and vehicle, the recovered energy may entirely or partially replace or supplement other energy sources. For example, while previously conventional heating apparatuses were operated using electrical currents provided by generators and vehicle batteries, those electrical currents often lead to high loadings of the electrical systems. Furthermore, the use of 12 or 24 volt systems also results in a considerable restriction with regard to the maximum possible power output of such systems. Proceeding from that prior art, it is now possible, through the use of the present invention, for the heating energy originating from the previously conventional energy sources to be selectively entirely or partially replaced with the recovered energy. This leads to a particularly significant unloading of the electrical systems.

If, in other applications, a particularly high level of heating power is desired, for example if the most complete possible exhaust-gas aftertreatment is demanded, then the recovered energy may also be used to heat the exhaust gas in addition to the previous heating energy sources, as a result of which considerably higher levels of heating power than before are made possible. Furthermore, it is now ensured that, in driving situations which fundamentally lead to cooling of the exhaust system because an insufficient quantity of hot exhaust gas is generated, direct heating of the “relatively cool” exhaust gases takes place and therefore the activity or effectiveness of the exhaust-gas purification components of the exhaust system is maintained (in particular in the case of diesel engines).

Finally, in step (e) of the invention, the end of the possibility of energy recovery is detected, after which the energy converter is deactivated and the provision of the recovered energy is ended. In this way, it is ensured that a vehicle is not braked, or has energy extracted from it in some other way, in a state when that energy is required primarily for other purposes. An example in this case is an acceleration process in which the available power or energy quantity should be used as completely as possible for accelerating the vehicle. In such a driving state, it would not be desirable, and would in part even be safety-relevant, if the available drive power were partially converted within the context of energy recovery. In step (e), therefore, the energy recovery is ended and the vehicle is, in a sense, placed into a standby state in which it remains until the possibility of energy recovery exists again.

In accordance with another feature of the invention, it is very particularly preferable if the above-described method is carried out at least when the drive device is at partial load or when the exhaust gas temperature is below a minimum value. In this case, a possible limit for a partial-load range is 80%. This means that energy recovery should be carried out only if the drive device of the motor vehicle is operated at a load of 80% or lower. Other load limits may be defined, for example at 60% or 30%, as a result of which it is ensured that no energy recovery is carried out if the engine or the drive device is operated at a power which lies above those part-load limits. The load limits may fundamentally also be linked to an average and/or present exhaust-gas temperature, such that heating is also for example already provided at relatively low temperatures despite high partial-load ranges (for example 80%). Conversely, in the case of high exhaust-gas temperatures, auxiliary heating may be dispensed with even if the partial load is very low and lies, for example, below 30%. The temperature which is used for controlling the auxiliary heating then constitutes a predefined minimum exhaust-gas temperature (for example 400° C., or 300° C. or even 200° C.) at which sufficient effectiveness and exhaust-gas aftertreatment by the exhaust-gas purification device is still ensured.

In accordance with a further feature of the invention, it is also very particularly advantageous if steps (a) to (e) are carried out by a control device which is connected to the components. In this case, a control device is to be understood to mean a device which is capable of detecting different parameter signals and/or measured values of a vehicle, analyzing them corresponding to predefined conditions, situations, states and/or rules, and outputting corresponding control commands. A control device of that type may physically be formed in one unit or else may be distributed in the vehicle between a multiplicity of so-called control units. In this case, it is also pointed out in particular that control programs are executed on control devices of that type in which the method steps are stored in the form of a program.

Control devices are found in virtually all modern vehicles and, through the use of corresponding adaptation of control programs, can also easily be set up and used to carry out the method according to the present invention. Control devices of that type are particularly powerful and can monitor a multiplicity of parameters, and take them into consideration for decision making, virtually in real time. Reference is also made in particular to a connection of control devices to navigation devices, which is advantageously possible within the context of the present invention.

In accordance with an added feature of the invention, provision is made for at least an energy absorption capability or an energy output capability of at least one energy storage device or of a consumer to be monitored continuously by the control device. In this case, provision may be made for the energy output capability and/or the energy absorption capability of the energy storage device and/or consumer to be monitored using one control device. Such consumers are for example the above-specified heating apparatus, or else other energy consumers such as for example control units, electric drives of hybrid vehicles or electric vehicles, or else those of energy storage devices, such as for example batteries or capacitors.

In this case, in particular, powerful capacitors are known which serve, in vehicles, for briefly buffering large energy quantities. Very particularly preferable is the use of double layer capacitors, also referred to as electrochemical double layer capacitors (EDLC) or supercapacitors. Double layer capacitors are composed of two electrodes which are wetted with an electrolyte. When a voltage is applied which is lower than the decomposition voltage of the electrolyte, ions of reversed polarity collect at the two electrodes. Those ions form a zone of immovable charge carriers, the layer thickness of which is only a small number of molecule layers. Double layer capacitors of that type have very high specific power densities (Watt/kg) in relation to batteries, which specific power densities are determined by the internal resistance. Such high power densities are favorable for applications for buffering consumers which briefly require or output a high current (in the automotive field addressed in this case, it is possible for a corresponding electromotive brake to be used in electric vehicles, hybrid vehicles and vehicles with a gyro drive because these have sufficiently large drive motors and energy storage devices). The capacitors can, in contrast to previously known batteries, buffer large quantities of electrical energy very quickly. These capacitors are therefore particularly suitable for the brief and rapid buffering of the recovered energy.

In this respect, it is advantageous to monitor the energy storage capacity and energy output capacity of such energy storage devices in order to temporarily buffer there the reclaimed energy which is provided by the energy converter. In this case, it should be noted that, if the reclaimed energy is buffered in a buffer, step (e) of the method according to the invention can provide a time delay between the deactivation of the energy converter and the end of the provision of the reclaimed energy. In the remaining time after the deactivation of the energy converter, the provision of the reclaimed energy can specifically take place through the use of the previously filled energy storage devices, which still output the buffered energy to the heating apparatus for a determined time period. In this way, heating can continue using the buffered energy even after an end of recovery. This is expedient in particular in idle phases which for example directly follow, or follow with a time delay, phases of energy recovery. An idle phase may for example constitute a waiting period at a traffic signal. Furthermore, in certain cases, it may be expedient to divide the recovered energy and conduct it to a multiplicity of consumers or storage devices. Therefore, it is possible for a very high output of power to occur during energy recovery in particular in vehicles with electric drives. This means that, in a very short time, a large quantity of energy is generated which must be consumed or stored. Such energy quantities may for example be monitored and distributed by a control device. In this case, it is then for example expedient to consume a part of the energy in a heating apparatus and to store another part of the energy in a storage device, with it being possible, as a function of the energy quantity to be absorbed, for both steps to be carried out in parallel or in succession.

In accordance with an additional feature of the invention, as already mentioned above, provision is advantageously made within the context of the present invention for the method according to step (b) to be carried out through the use of at least one electric motor or generator. Electric motors and/or generators of that type are already used in modern vehicles, for example with hybrid drive or with purely electrical drive, and may be utilized for generating electrical currents, and therefore as energy converters. However, it is possible even in vehicles which have heretofore been driven solely by internal combustion engines for electric motors or generators of that type to additionally be disposed in the vehicle as drives or as energy converters.

In accordance with yet another feature of the invention, it is preferable within the context of the present method for at least one electrically heatable honeycomb body to be used, as a heating apparatus, for carrying out step (d). An electrically heatable honeycomb body of this type may optionally be formed from ceramics or from metal or from a combination of both material types. Heatable honeycomb bodies of this type are also already known in the prior art in a multiplicity of refinements, and have also been proven. Honeycomb bodies which are constructed with at least partially structured sheet-metal layers which form coiled flow paths which are electrically insulated from one another and which extend over the cross section of the honeycomb body, are preferable in this case.

In accordance with yet a further feature of the invention, it is also particularly advantageous if an exhaust-gas mass flow is at least partially recirculated during step (d). In this way, the relatively cold exhaust-gas mass flow which is to be heated can be considerably reduced in terms of mass by virtue of the exhaust-gas mass flow being at least partially conducted back into the internal combustion engine. As a result of the reduction of the exhaust-gas mass flow to be heated, the remaining exhaust-gas mass flow which is not recirculated can be heated to a higher temperature, or it is possible for the heating power required for heating to be correspondingly reduced without a temperature reduction. Alternatively, both possibilities may also be realized. In particular, a reduction in the heating power relieves the electrical system of the vehicle of load and permits a longer heating time with the recovered energy.

With the objects of the invention in view, there is concomitantly provided a motor vehicle, comprising at least one drive device, an exhaust system with at least one regulable heating apparatus to be placed in contact with exhaust gas from the at least one drive device, and a control device connected at least to the at least one heating apparatus for carrying out the method according to the invention.

Other features which are considered as characteristic for the invention are set forth in the appended claims, noting that the features listed individually in the claims can be combined with one another in any desired technologically expedient manner and highlight further embodiments of the invention.

Although the invention is illustrated and described herein as embodied in a motor vehicle and a method for operating a motor vehicle with an exhaust-gas heating apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a side-elevational view of a motor vehicle for carrying out the method according to the invention;

FIG. 2 is a bottom-plan view of the vehicle according to FIG. 1;

FIG. 3 is a bottom-plan view of a second embodiment of a motor vehicle; and

FIG. 4 is a bottom-plan view of a third embodiment of a motor vehicle.

### DETAILED DESCRIPTION OF THE INVENTION

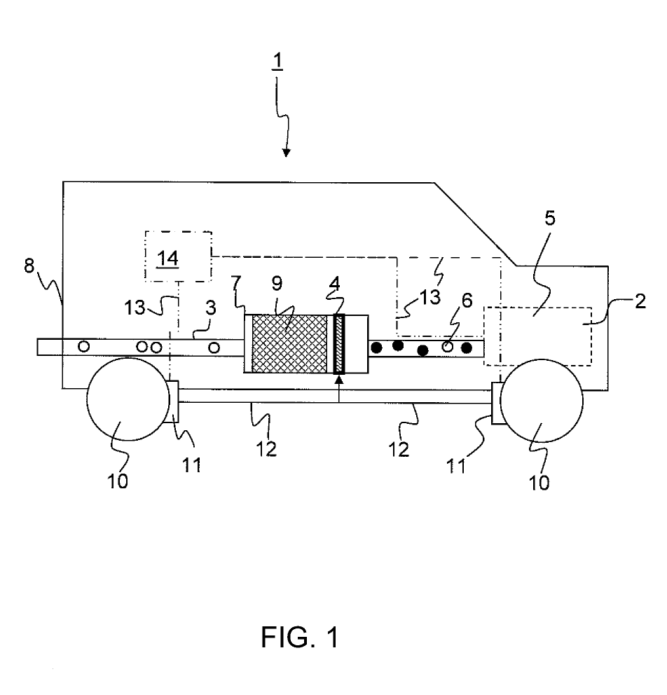

Referring now to the figures of the drawings in detail and first, particularly, to FIG. 1 thereof, there is seen a motor vehicle 1 for carrying out the method according to the invention. The motor vehicle 1 is composed of various components, which include inter alia a drive device 2, an exhaust system 3 and a heating apparatus 4. The drive device 2 is embodied as an internal combustion engine 5 which produces an exhaust gas 6 and conveys that exhaust gas 6 through the exhaust system 3 to a catalytic converter 7, from where the exhaust gas 6 is conducted, having been treated, through a rear part of the exhaust system 3 to a vehicle rear side 8, where the exhaust gas 6 emerges into the atmosphere. The catalytic converter 7 also includes, in addition to the heating apparatus 4, a (at least one further) honeycomb body 9 which may be formed from metal or from ceramic and which may be provided with various catalytically active, adsorbing or other coatings. In the honeycomb body 9, the previously incompletely “purified” exhaust gas 6 is treated at corresponding temperatures. The heating apparatus 4 is disposed upstream of the honeycomb body 9 in order to attain the temperatures which are expedient or required for the conversion.

Energy converters 11, which are disposed at each wheel 10, are connected over lines 12 to the heating apparatus 4. Furthermore, the energy converters 11 are connected over control lines 13 to a control device 14.

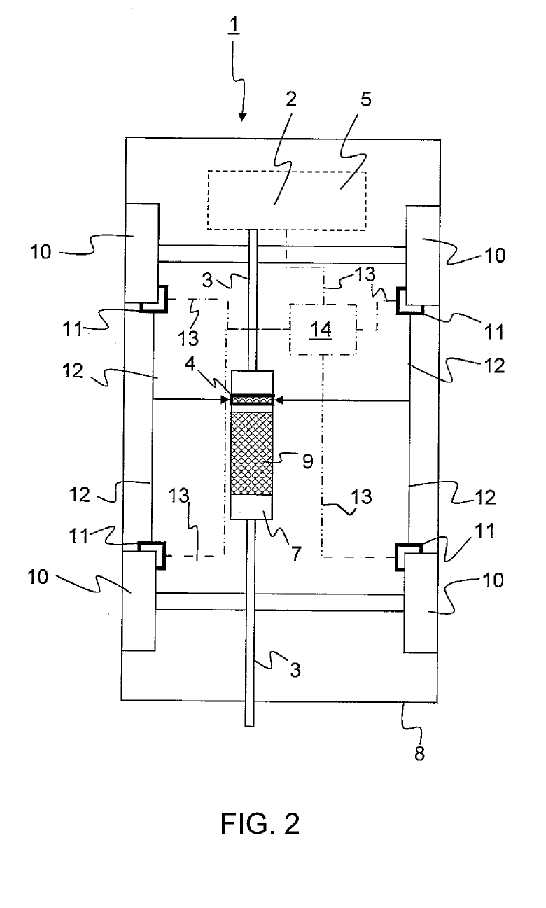

FIG. 2 illustrates the motor vehicle 1 of FIG. 1 in a plan view. In that figure, it is possible again to see the control device 14 which is connected over control lines 13 to each of the four energy converters 11 and additionally to the internal combustion engine 5. In this case, the control lines 13 serve selectively to transmit control commands or to query measurement values and parameters. The expression “control line” is therefore also to be understood to mean a signal transmission line. FIG. 2 also clearly shows that an energy converter 11 is disposed at each of the wheels 10. The electrical energy which is recovered in each of the energy converters 11 is conducted over the lines 12 directly into the heating apparatus 4. In the embodiment shown, the method according to the invention is carried out by virtue of the control device 14 firstly detecting the presence of the possibility of energy recovery, and subsequently outputting signals over the control lines 13 to the energy converters 11 in order to activate the latter. After the activation of the energy converters 11, the kinetic energy of the rotating wheels is recovered through the use of the energy converters 11 and is transmitted in the form of an electrical current over the lines 12 to the heating apparatus 4, where the electrical current is introduced corresponding to illustrated arrows and is converted into heat in order to heat the exhaust gas 6. In the illustrated exemplary embodiment, the energy converters 11 are constructed as co-rotating generators which are permanently coupled to the wheels 10. The energy converters 11 may, for example, be constructed in such a way that, in an inactive state, they rotate together with the wheels virtually without resistance, and do not brake the wheels. It is only upon activation that a small exciting current can be applied to the generators, as a result of which they are activated as generators and start to generate electrical energy. In another embodiment, it is by all means possible for the generators to co-rotate continuously, and for the line contact to the heating apparatus 4 to be produced, and therefore for a consumer circuit to be closed, only in the event of an activation.

It is therefore possible, for example, for simple control to take place selectively through the use of the activation of the consumer in the form of the heating apparatus 4 or through the use of the application of an exciting current to the generators.

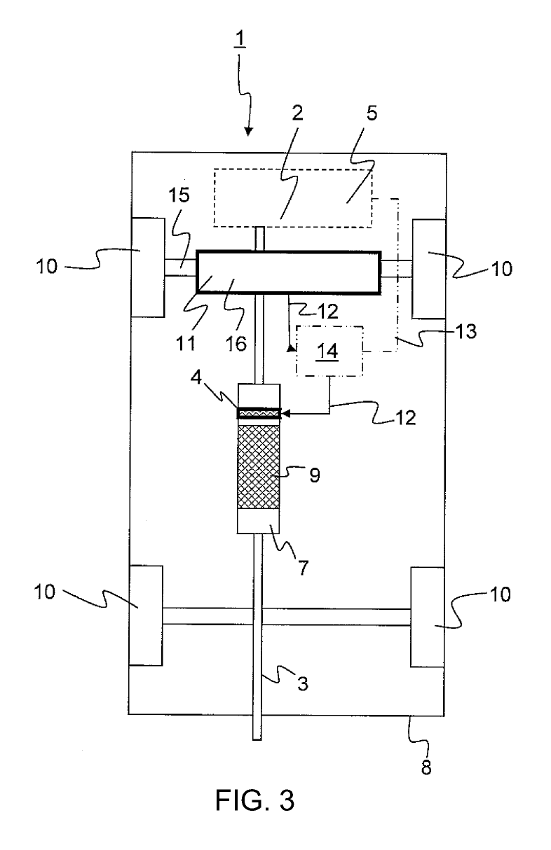

FIG. 3 now illustrates a plan view of a motor vehicle 1 in which the drive device 2 is again constructed as an internal combustion engine 5. In addition, an electric motor 16 is disposed, as an energy converter 11, on a front axle 15 of the motor vehicle 1. The construction of the catalytic converter 7 corresponds to that of the catalytic converter 7 described above in connection with FIGS. 1 and 2. In this embodiment, the control device 14 is again connected through the use of a control line 13 to the internal combustion engine 5, and can thus detect measurement values and parameters from the internal combustion engine 5. In addition, the control device 14 is connected over lines 12 both to the electric motor 16 and also to the heating apparatus 4. If the control device 14 now detects a possibility of energy recovery, then the control device 14 activates the electric motor 16 as an energy converter 11, in such a way that the electric motor 16 provides energy in the form of an electrical current over the lines 12. That electrical current is conducted by the control device 14 to the heating apparatus 4 and is used there to heat the exhaust gas 6 flowing through the exhaust system 3. In this case, the vehicle which is shown corresponds substantially to a so-called hybrid vehicle in which the drive energy is firstly generated in an internal combustion engine and is partially transmitted directly from the internal combustion engine to the wheels 10. In other driving states, the energy which is generated by the internal combustion engine 5 is buffered and subsequently transmitted to the wheels 10 through the use of the electric motor 16. As shown above, the present invention can likewise be advantageously used in a hybrid vehicle of that type.

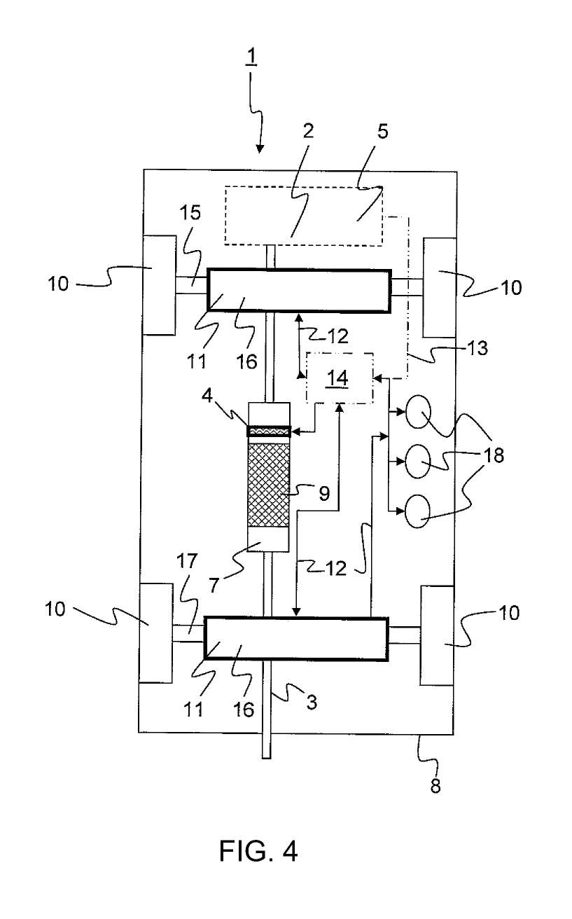

FIG. 4 now shows a plan view of a further possible embodiment of a motor vehicle 1 which is suitable for carrying out the method according to the invention. In this case, too, the drive device 2 is again constructed as an internal combustion engine 5. In each case one respective electric motor 16 is situated at the front axle 15 and at a rear axle 17. Both electric motors 16 can be used as energy converters 11. In contrast to the embodiment shown in FIG. 3, the control device 14 can therefore receive electrical energy from two drive axles 15, 17 during energy recovery. Furthermore, this exemplary embodiment, however, also has an energy storage device 18 which is formed with a plurality of so-called supercapacitors. The control device 14 can therefore be adapted particularly effectively to complex driving states and vehicle states, in particular states of the electrical system. It is thus possible, for example, for the electrical energy which is provided during energy recovery by the electric motors 16 to be introduced selectively into the heating apparatus 4 or into the energy storage device 18 for buffering. If the state of energy recovery is then ended and electrical energy is no longer provided by the energy converters 11, then the energy which is stored in the supercapacitors of the buffer 18 can be used selectively for driving the electric motors 16 or for heating the heating apparatus 4. If the heating apparatus 4 is heated, it is then possible for exhaust gases which are produced, for example during a subsequent period of full-load operation of the internal combustion engine 5, to be particularly effectively purified at high temperatures without a time delay. Through the use of the energy buffered in the energy storage device 18 or the energy which is provided by the energy converter 11, the exhaust system 3, and in particular the catalytic converter 7, can thus immediately impart its full effect again in the event of a renewed generation of exhaust gases and need not firstly be heated, which would otherwise necessitate additional external heating energy or a relatively long time period with hot exhaust gases, in which time period only partial or poor exhaust-gas purification would, however, be obtained. In this case, as indicated by the two lines 12, the recovered energy is supplied in parallel to the energy storage devices 18 and to the heating apparatus 4.

Furthermore, the present invention is otherwise not restricted to the illustrated embodiments or exemplary embodiments. Within the context of the invention, numerous variants of the illustrated configurations of energy converters, control devices and heating apparatuses within the exhaust system are by all means possible without departing from the concept of the invention. It is thus possible, for example, for a multiplicity of heating apparatuses to be used instead of the one heating apparatus. Furthermore, as already indicated, it is possible for the control device 14 to give consideration to different numbers of energy converters 11 and energy storage devices 18 as well as different types of consumers.

1. A method for operating a motor vehicle having components including a drive device, an exhaust system for exhaust gases from the drive device, at least one heating apparatus of the exhaust system, and at least one energy converter, the method comprising the following steps:
(a) detecting a possibility of energy recovery;
(b) activating the at least one energy converter;
(c) supplying energy recovered by the at least one energy converter to the heating apparatus;
(d) operating the heating apparatus in order to heat the exhaust gas with the recovered energy; and
(e) detecting an end of the possibility of energy recovery and subsequently deactivating the energy converter and ending the energy recovery.

2. The method according to claim 1, which further comprises carrying out the method at least when the drive device is at partial load or when an exhaust gas temperature is below a minimum value.

3. The method according to claim 1, which further comprises carrying out steps to by a control device connected to the components.

4. The method according to claim 3, which further comprises continuously monitoring at least an energy absorption capability or an energy output capability of at least one energy storage device or of a consumer, with the control device.

5. The method according to claim 1, which further comprises carrying out step with at least one electric motor or generator.

6. The method according to claim 1, which further comprises providing at least one electrically heatable honeycomb body as the at least one heating apparatus, for carrying out step.

7. The method according to claim 1, which further comprises at least partially recirculating an exhaust-gas mass flow during step.

8. A motor vehicle, comprising:
at least one drive device;
an exhaust system with at least one regulable heating apparatus to be placed in contact with exhaust gas from said at least one drive device; and
a control device connected at least to said at least one heating apparatus for carrying out the method according to claim 1.
